(19) United States
(12) Patent Application Publication
(10) Pub. No.: US 2020/0100542 A1
(43) Pub. Date: Apr. 2, 2020

(54) TOBACCO CARTRIDGE AND CIGARETTE AIR HEATING DEVICE THEREOF

(71) Applicants: Gongyun Long, Shenzhen (CN); Hong Liu, Shenzhen (CN)

(72) Inventors: Gongyun Long, Shenzhen (CN); Hong Liu, Shenzhen (CN)

(21) Appl. No.: 16/584,955

(22) Filed: Sep. 27, 2019

(30) Foreign Application Priority Data
Sep. 27, 2018 (CN) 201811131318.8

(51) Int. Cl. A24F 47/00; A24D 1/14; H05B 3/46

(52) U.S. Cl. CPC A24F 47/008; H05B 2203/022; H05B 3/46; A24D 1/14

(57) ABSTRACT

The invention discloses a tobacco cartridge and a cigarette air heating device thereof; the cartridge comprises a tobacco container that has openings at both ends where a mental foil is encapsulated; the tobacco can be sealed with the metal foil to prevent moisture; the metal foil has low strength and is convenient for puncturing, with the advantages of resistant storage, convenient transportation, and quick use; the central portion of the cigarette air heating device has an air guiding device that comprises a base and an air guiding tube; when in use, the tube is inserted into the cartridge and sequentially pierces through two layers of metal foil; the cartridge conducts heat flow to the cartridge, so that the heating is more uniform, and the hot air flow can be buffered, which enables that the air temperature in the later period is longer and the taste is more pure.

### BACKGROUND OF THE INVENTION

### 1. Field of the Invention

The invention relates to a tobacco product and a cigarette heating device, and in particular to a tobacco cartridge and a cigarette air heating device thereof.

### 2. Description of the Related Art

At present, the cigarettes used in the cigarette air heating device are long cigarettes or short cigarettes with the same structure of ordinary cigarettes. These long or short cigarettes have openings at both ends, so that the tobacco therein is susceptible to moisture and qualitative change. How to solve the problem that the tobacco is susceptible to moisture and qualitative change has become a key technical issue that needs to be solved urgently.

Moreover, the current common cigarette air heating device uses a heating element to heat the air to generate a hot air flow, and the hot air flow directly enters the bottom of the cigarette cup where the long cigarette or the short cigarette is placed in the combustion chamber; the heating method has the following problems: (1) the hot air flow enters from the bottom of the cigarette cup where the long cigarette or the short cigarette is placed, so that the long cigarette or the short cigarette is unevenly heated; (2) when the user is smoking, the hot air will enter faster from the bottom of the cigarette cup into the long or the short cigarettes, which results in a lower air temperature in the later period of smoking, which affects the taste of smoking.

### SUMMARY OF THE INVENTION

The technical issues to be solved by the invention: in view of the above problems in the prior art, the invention provides a tobacco cartridge and a cigarette air heating device thereof; the built-in tobacco can be sealed with the metal foil of the tobacco cartridge to prevent moisture in the built-in tobacco; moreover, the metal foil has low strength and is convenient for puncturing to realize that the smoke generated by the heat is exported with the airflow, and has the advantages of resistant storage, convenient transportation, convenient and quick use; on the one hand, the tobacco cartridge uses a cigarette air heating device to conduct heat flow generated by the heat generating component to the tobacco cartridge through the air guiding tube, so that the tobacco heating is more uniform, on the other hand, the hot air flow can be buffered, which enables that the air temperature in the later period of smoking is longer and the taste of the smoking is more pure.

In order to solve the technical issues above, the invention adopts the technical solutions as follows:

The invention provides a tobacco cartridge, comprising a tobacco container with built-in tobacco, wherein the tobacco container is provided with openings at both ends and a mental foil is encapsulated at the opening.

Preferably, the metal foil is an aluminum foil.

Preferably, the tobacco container is made of metal.

Preferably, the tobacco container is in a straight-pipe shape or a trumpet-pipe shape, and the two opening ends are provided with a bending edge for encapsulating the metal foil.

The invention also provides a cigarette air heating device of the tobacco cartridge, comprising a casing with a pipe inside, wherein one end of the pipe is equipped with a heat generating component, and the other end thereof is connected with a mouthpiece kit; the central portion of the pipe is provided with an air guiding device, and the air guiding device comprises a base and at least one air guiding tube disposed on the base; the outer wall of the air guiding tube is equipped with air guiding holes, and the base is inserted and fixed in the pipe; when in use, the air guiding tube is inserted into the tobacco cartridge and sequentially pierces through the two layers of metal foil.

Preferably, the base is equipped with mounting holes penetrating in the axial direction, and the air guiding tube is inserted into the mounting holes.

Preferably, the outer wall of the base is embedded with sealing rings.

Preferably, the base is equipped with airpath holes penetrating in the axial direction.

Preferably, the base is cylindrical.

Preferably, the end of the air guiding tube is equipped with a sharp portion.

Preferably, the end of the sharp portion is equipped with air guiding holes.

Preferably, the outer wall of the base and the inner wall of the pipe are in an interference fit.

Preferably, one end of the casing is equipped with a plug, and the other end thereof is equipped with a positioning sleeve; one end of the pipe is connected with the plug, and the other end thereof is connected with the poisoning sleeve and a gap is formed between the inner wall of the casing and the outer wall of the pipe; the heat generating component is installed on the plug.

Preferably, the mouthpiece kit comprises a nozzle holder with through inner holes; the nozzle holder is inserted into the positioning sleeve and is embedded with a second sealing ring therebetween and the inner wall of the positioning sleeve; a nozzle tube is inserted into the inner hole of the nozzle holder, and the central portion of the nozzle tube is equipped with a positioning step extruded laterally; the portion of the nozzle tube inside the positioning step is sleeved with a spring, and the portion of the nozzle tube outside the positioning step is sleeved with a pressing sleeve; the pressing sleeve and the inner wall of the inner hole of the nozzle holder are in an interference fit.

Compared with the prior art, the tobacco cartridge of the invention has the following advantages: the tobacco cartridge of the invention comprises a tobacco container with built-in tobacco, wherein the tobacco container is equipped with openings at both ends and a mental foil is encapsulated at the opening; the built-in tobacco can be sealed with the metal foil of the tobacco cartridge to prevent moisture in the built-in tobacco; moreover, the metal foil has low strength and is convenient for puncturing to realize that the smoke generated by the heat is exported with the airflow, and has the advantages of resistant storage, convenient transportation, convenient and quick use.

Compared with the prior art, the cigarette air heating device of the tobacco cartridge of the invention has the following advantages: the central portion of the cigarette air heating device of the tobacco cartridge of the invention is equipped with an air guiding device, and the air guiding device comprises a base and at least one air guiding tube disposed on the base; the outer wall of the air guiding tube is equipped with air guiding holes, and the base is inserted and fixed in the pipe; when in use, the air guiding tube is inserted into the tobacco cartridge and sequentially pierces through the two layers of metal foil; on the one hand, the tobacco cartridge conducts heat flow generated by the heat generating component to the tobacco cartridge through the air guiding tube, so that the tobacco heating is more uniform, on the other hand, the hot air flow can be buffered, which enables that the air temperature in the later period of smoking is longer and the taste of the smoking is more pure.

### BRIEF DESCRIPTION OF THE DRAWINGS

FIG. 1 is a sectional view illustrating the structure of the tobacco cartridge in Embodiment 1 of the invention.

FIG. 2 is a sectional view illustrating the structure of the cigarette air heating device of the tobacco cartridge in Embodiment 1 of the invention.

FIG. 3 is a sectional view illustrating the structure of the air guiding device in Embodiment 1 of the invention.

FIG. 4 is a sectional view illustrating the structure of the air guiding device in Embodiment 2 of the invention.

In the figures, 1 refers to the tobacco container; 11 refers to the bending edge; 2 refers to the metal foil; 3 refers to the casing; 31 refers to the pipe; 32 refers to the plug; 33 refers to the positioning sleeve; 4 refers to the heat component; 5 refers to the mouthpiece kit; 51 refers to the nozzle holder; 511 refers to the second sealing ring; 52 refers to the nozzle tube; 521 refers to the positioning step; 53 refers to the spring; 54 refers to the pressing sleeve; 6 refers to the air guiding device; 61 refers to the base; 611 refer to the mounting holes; 612 refers to the sealing ring; 613 refer to the airpath holes; 62 refers to the air guiding tube; 621 refer to the air guiding holes; 622 refers to the sharp portion.

### DETAILED DESCRIPTION OF THE PREFERRED EMBODIMENTS

### Embodiment 1

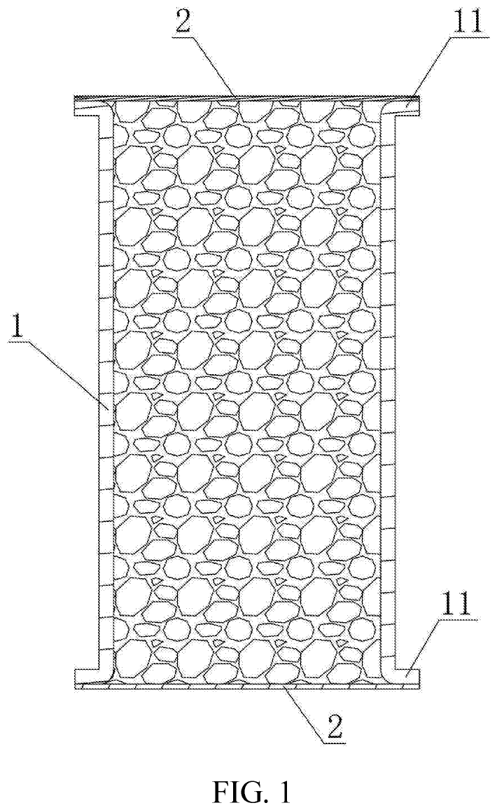

As shown in FIG. 1, the tobacco cartridge in the embodiment comprises a tobacco container 1 with built-in tobacco, wherein the tobacco container 1 is equipped with openings at both ends and a mental foil 2 is encapsulated at the opening; the built-in tobacco can be sealed with the metal foil 2 of the tobacco cartridge to prevent moisture in the built-in tobacco; moreover, the metal foil 2 has low strength and is convenient for puncturing to realize that the smoke generated by the heat is exported with the airflow, and has the advantages of resistant storage, convenient transportation, convenient and quick use.

The tobacco built in the tobacco container 1 may be a tobacco sheet, cut tobacco, tobacco particles, tobacco powder, or a combination of any two or more of the above, and may be added as needed, such as a fragrance and other additives. The tobacco built in the tobacco container 1 in the embodiment is tobacco granules, and the steps for preparing the tobacco cartridge are as follows: the bottom of the tobacco container 1 is first sealed with the metal foil 2, then the tobacco particles are filled, and finally the top is sealed with the metal foil 2.

In the embodiment, the tobacco container 1 is made of metal and has the advantage of high strength; in the embodiment, the tobacco container 1 is made of aluminum, and it is possible to prepare the tobacco container 1 with other metals such as iron, copper or the like as needed. Moreover, a rigid non-metal such as ceramics may be used as needed to prepare the tobacco container 1, and a flexible material such as silicone may be used as needed to prepare the tobacco container 1; the main reason for adopting ceramics and silicone is that ceramics and silicone are stable in heat and do not produce odors. In the light of this, those skilled in the art can also prepare the tobacco container 1 by using any other materials similar to ceramics and silicone which are stable in heat resistance and which do not produce odor.

In the embodiment, the metal foil 2 is an aluminum foil which has the advantages of being soft and easy to break, and does not generate odor when heated.

In the embodiment, the tobacco container 1 is in a straight-pipe shape, and the two opening ends are equipped with a bending edge 11 for encapsulating the metal foil 2; the straight-pipe shape can be easily adapted to the tubular structure and has a larger storage capacity; the bending edge 11 facilitates the encapsulation of the metal foil 2, so that the contact area of the package metal foil 2 and the tobacco container 1 is larger, and the sealing of the package is better. Moreover, the tobacco container 1 can also be formed into a trumpet-pipe shape (round-table shape) as needed, or other shaped strip structures can be formed as needed.

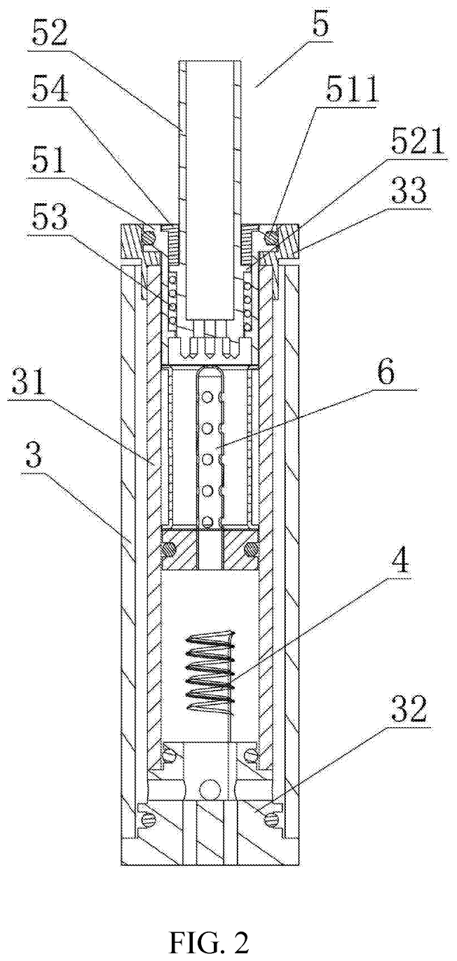

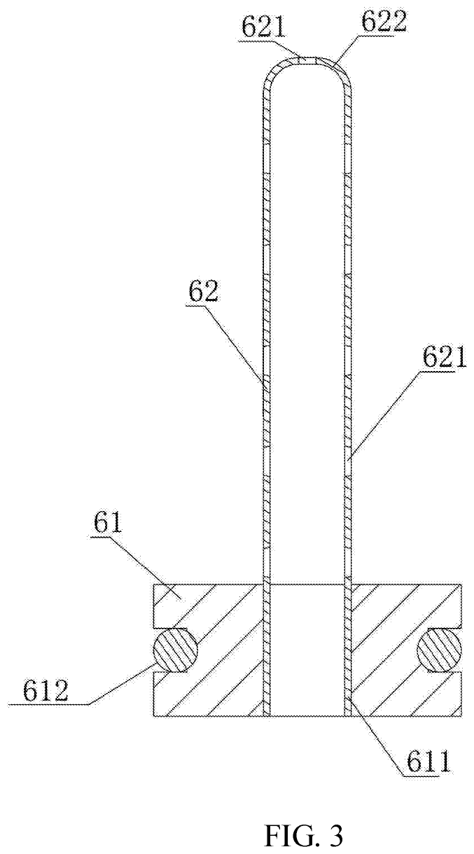

As shown in FIGS. 2 and 3, the cigarette air heating device of the tobacco cartridge comprises a casing with a pipe 31 inside, wherein one end of the pipe 31 is equipped with a heat generating component 4, and the other end thereof is connected with a mouthpiece kit 5; the central portion of the pipe 31 is equipped with an air guiding device 6, and the air guiding device 6 comprises a base 61 and at least one air guiding tube 62 disposed on the base 61; the outer wall of the air guiding tube 62 is equipped with air guiding holes 621, and the base 61 is inserted and fixed in the pipe 31; when in use, the air guiding tube 62 is inserted into the tobacco cartridge and sequentially pierces through the two layers of metal foil 2, which enables that the opening on the metal foil 2 at one end is used for air inlet, and the opening on the metal foil 2 at the other end is used for air outlet. The use of the cigarette air heating device of the tobacco cartridge and the tobacco cartridge of the invention perfectly solves the technical problem of the built-in tobacco moisture deterioration, on the one hand, the tobacco cartridge conducts heat flow generated by the heat generating component 4 to the tobacco cartridge through the air guiding tube 62, so that the tobacco heating is more uniform, on the other hand, the air guiding tube 62 is disposed between the heat generating component 4 and the tobacco cartridge, so the hot air flow can be buffered, which enables that the air temperature in the later period of smoking is longer and the taste of the smoking is more pure. In the embodiment, the central portion of the base 61 is equipped with an air guiding tube 62, and it is also possible to arrange a plurality of air guiding tubes 62 as needed.

As shown in FIG. 2, one end of the casing 3 is installed with a plug 32, and the other end thereof is installed with a positioning sleeve 33; one end of the pipe 3 is connected with the plug 32, and the other end thereof is connected with the poisoning sleeve 33 and a gap is formed between the inner wall of the casing 3 and the outer wall of the pipe 31; the heat generating component 4 is installed on the plug 32. With the above structure, the tobacco tube 31 and the casing 3 are formed into a nested structure, which is convenient and quick to install, and the inner wall of the casing 3 and the outer wall of the pipe 31 form a space to ensure that the casing 3 has a good hand-feeling.

As shown in FIG. 2, the heat generating component 4 is a resistance heating wire, and the resistance heating wire is wound to form into a tubular shape; moreover, the heat generating component 4 may be other heat generating components such as a heat generating sheet/plate, a heat generating rod/needle/strip, a heat generating tube, or the like as needed. The electrode terminal of the heat generating component 4 can be directly fixed to the plug 32 and connected to an external power source, or the electrode component can be fixed on the plug 32 as needed. The electrode terminal of the heat generating component 4 is connected to the electrode assembly and is indirectly connected to the external power source through the electrode assembly.

As shown in FIG. 2, the mouthpiece kit 5 comprises a nozzle holder 51 with through inner holes; the nozzle holder 51 is inserted into the positioning sleeve 33 and is embedded with a second sealing ring 511 therebetween and the inner wall of the positioning sleeve 33; a nozzle tube 52 is inserted into the inner hole of the nozzle holder 51, and the central portion of the nozzle tube 52 is equipped with a positioning step 521 extruded laterally; the portion of the nozzle tube 52 inside the positioning step 521 is sleeved with a spring 53, and the portion of the nozzle tube 52 outside the positioning step 521 is sleeved with a pressing sleeve 54; the pressing sleeve 54 and the inner wall of the inner hole of the nozzle holder 51 are in an interference fit. Since the nozzle tube passes through the positioning step 521 and the inside thereof is sleeved with a sleeve to form a pressable elastic structure, when the tobacco cartridge is needed, the mouthpiece kit 5 is removed, the tobacco cartridge is inserted into the pipe 31, the mouthpiece kit 5 is installed, and the nozzle tube 52 is pressed, so that the nozzle tube 52 is pressed down; therefore, the air guiding tube 62 of the air guiding device 6 is inserted into the tobacco cartridge and the two layers of the metal foil 2 are pierced in turn, and it is ready to use, which has the advantages of convenient and quick use.

As shown in FIG. 3, the base 61 is equipped with mounting holes 611 penetrating in the axial direction, and the air guiding tube 62 is inserted into the mounting holes 611; the embedded mounting structure makes the installation of the air guiding tube 62 more convenient and quick, and the embedded mounting structure does not need to be welded, which can prevent the solder from being heated to generate harmful substances.

As shown in FIG. 3, the outer wall of the base 61 is embedded with sealing rings 612; on the one hand, the sealing ring 612 can realize the sealing between the outer wall of the base 61 and the inner wall of the pipe 31, and on the other hand, it can ensure sufficient damping between the outer wall of the base 61 and the inner wall of the pipe 31, so that the insertion and removal of the air guiding device 6 is better and less likely to wear.

As shown in FIG. 3, in the embodiment, the base 61 is cylindrical, and the structure facilitates the cooperation between the outer wall of the base 61 and the inner wall of the pipe 31, so that the insertion and removal of the air guiding device 6 is more stable.

As shown in FIG. 3, the end of the air guiding tube 62 is equipped with a sharp portion 622; the sharp portion 622 may be in the form of a needle tip or a sheet as needed, as long as it is easy to pierce the metal foil 2, and the sheet opening is relatively more permeable than the needle tip. Moreover, since the metal foil 2 is the aluminum foil, it is soft and easy to break, in order to prevent the air guiding tube 62 from piercing the metal foil 2, the gap of the puncturing mouth is small, and further, a plurality of air guiding ribs and/or air guiding grooves may be installed on the outer wall of the air guiding tube 62 along the longitudinal direction thereof, so that the air guiding ribs and the air guiding grooves can form a good air guiding gap after air guiding tube 62 pierces the metal foil 2.

As shown in FIG. 3, the end of the sharp portion 622 is equipped with air guiding holes 621, so that the end of the sharp portion 622 can also directly conduct hot air, which enables that the amount of smoke of the cigarette air heating device of tobacco cartridge in the embodiment is larger.

As shown in FIG. 3, the outer wall of the base 61 and the inner wall of the pipe 31 are in an interference fit, which enables the insertion and removal of the air guiding device 6 more stable and reliable.

### Embodiment 2

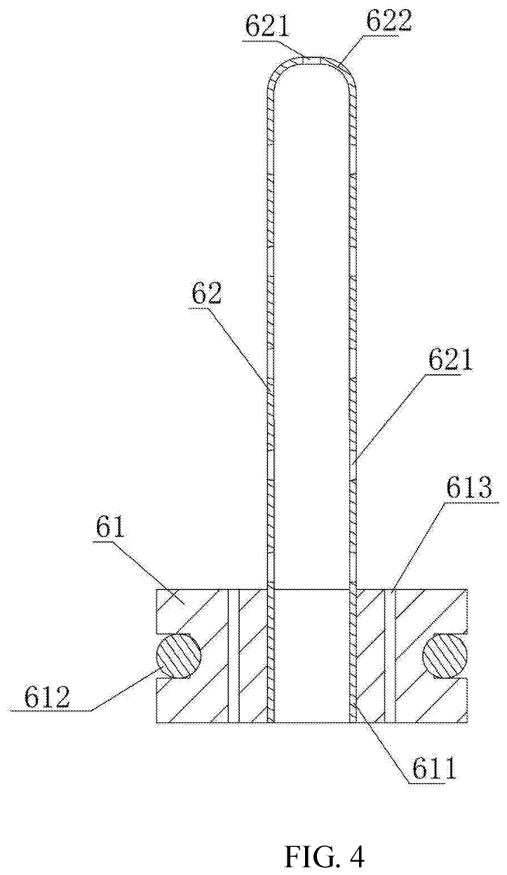

The embodiment is basically the same as the Embodiment 1, and the main differences are as follows: as shown in FIG. 4, the base 61 is provided with airpath holes 613 penetrating in the axial direction; the amount of air percussion on the base 61 can be increased by the airpath holes 613, which enables that the amount of smoke of the cigarette air heating device of tobacco cartridge in the embodiment is larger.

The above description are only preferred embodiments of the invention, and the scope of protection of the invention is not limited to the above embodiments, and all the technical solutions based on the inventive concept shall all fall within the protection scope of the invention. It should be noted to those skilled in the art that any improvements and modifications without departing from the principles of the invention should be considered as the protection scope of the invention.

1. A tobacco cartridge, comprising a tobacco container (1) with built-in tobacco, wherein the tobacco container (1) is provided with openings at both ends and a mental foil (2) is encapsulated at the opening.

2. The tobacco cartridge according to claim 1, wherein the metal foil (2) is an aluminum foil.

3. The tobacco cartridge according to claim 1, wherein the tobacco container (1) is made of metal.

4. The tobacco cartridge according to claim 1 or 2 or 3, wherein the tobacco container (1) is in a straight-pipe shape or a trumpet-pipe shape, and the two opening ends are provided with a bending edge (11) for encapsulating the metal foil (2).

5. A cigarette air heating device of the tobacco cartridge according to claim 1, comprising a casing with a pipe (31) inside, wherein one end of the pipe (31) is provided with a heat generating component (4), and the other end thereof is connected with a mouthpiece kit (5); the central portion of the pipe (31) is provided with an air guiding device (6), and the air guiding device (6) comprises a base (61) and at least one air guiding tube (62) disposed on the base (61); the outer wall of the air guiding tube (62) is equipped with air guiding holes (621), and the base (61) is inserted and fixed in the pipe (31); when in use, the air guiding tube (62) is inserted into the tobacco cartridge and sequentially pierces through the two layers of metal foil (2).

6. The cigarette air heating device of the tobacco cartridge according to claim 5, wherein the base (61) is provided with mounting holes (611) penetrating in the axial direction, and the air guiding tube (62) is inserted into the mounting holes (611).

7. The cigarette air heating device of the tobacco cartridge according to claim 6, wherein the outer wall of the base (61) is embedded with sealing rings (612).

8. The cigarette air heating device of the tobacco cartridge according to claim 7, wherein the base (61) is provided with airpath holes (613) penetrating in the axial direction.

9. The cigarette air heating device of the tobacco cartridge according to claim 8, wherein the base (61) is cylindrical.

10. The cigarette air heating device of the tobacco cartridge according to claim 9, wherein the end of the air guiding tube (62) is equipped with a sharp portion (622).

11. The cigarette air heating device of the tobacco cartridge according to claim 6, wherein the end of the sharp portion (622) is equipped with air guiding holes (621).

12. The cigarette air heating device of the tobacco cartridge according to claim 5, wherein the outer wall of the base (61) and the inner wall of the pipe (31) are in an interference fit.

13. The cigarette air heating device of the tobacco cartridge according to claim 12, wherein one end of the casing (3) is equipped with a plug (32), and the other end thereof is equipped with a positioning sleeve (33); one end of the pipe (3) is connected with the plug (32), and the other end thereof is connected with the poisoning sleeve (33) and a gap is formed between the inner wall of the casing (3) and the outer wall of the pipe (31); the heat generating component (4) is installed on the plug (32).

14. The cigarette air heating device of the tobacco cartridge according to claim 13, wherein the mouthpiece kit (5) comprises a nozzle holder (51) with through inner holes; the nozzle holder (51) is inserted into the positioning sleeve (33) and is provided with a second sealing ring (511) therebetween and the inner wall of the positioning sleeve (33); a nozzle tube (52) is inserted into the inner hole of the nozzle holder (51), and the central portion of the nozzle tube (52) is provided with a positioning step (521) extruded laterally; the portion of the nozzle tube (52) inside the positioning step (521) is sleeved with a spring (53), and the portion of the nozzle tube (52) outside the positioning step (521) is sleeved with a pressing sleeve (54); the pressing sleeve (54) and the inner wall of the inner hole of the nozzle holder (51) are in an interference fit.
